(19) United States
(12) Patent Application Publication
(10) Pub. No.: US 2024/0160232 A1
(43) Pub. Date: May 16, 2024

(54) ROTARY DRIVING DEVICE AND METHOD FOR CORRECTING SYSTEM ERROR OF ROTARY DRIVING DEVICE

(71) Applicant: NINGBO INSTITUTE OF MATERIALS TECHNOLOGY AND ENGINEERING, CHINESE ACADEMY OF SCIENCES, Ningbo (CN)

(72) Inventors: Qingying CHEN, Ningbo (CN); Guilin YANG, Ningbo (CN); Chi ZHANG, Ningbo (CN); Weijun WANG, Ningbo (CN)

(21) Appl. No.: 18/416,923

(22) Filed: Jan. 19, 2024

Related U.S. Application Data
(63) Continuation of application No. PCT/CN2021/127461, filed on Oct. 29, 2021.

(30) Foreign Application Priority Data
Aug. 13, 2021 (CN) 202110929177.X

(51) Int. Cl. G05D 17/02; G05D 13/62

(52) U.S. Cl. CPC G05D 17/02; G05D 13/62

(57) ABSTRACT

A rotary driving device and a method for correcting a system error of the rotary driving device are provided. The rotary driving device includes a driven assembly, a driving assembly, a torque transmission member, a first torque sensor, and a second torque sensor. The driving assembly includes a fixed component and a rotating component, the rotating component is rotatably connected to the fixed component, the torque transmission member is connected to the rotating component and the driven assembly, the rotating component is configured to drive the driven assembly to rotate through the torque transmission member. The first torque sensor is connected to the fixed component and the torque transmission member, and the second torque sensor is disposed on the driven assembly.

### CROSS-REFERENCE TO RELATED APPLICATIONS

This application is a continuation of international patent application No. PCT/CN2021/127461, filed on Oct. 29, 2021, which itself claims priority to Chinese patent application No. 202110929177.X, filed on Aug. 13, 2021, and titled “ROTARY DRIVING DEVICE AND METHOD FOR CORRECTING SYSTEM ERROR OF ROTARY DRIVING DEVICE”. The content of the above identified application is hereby incorporated herein in their entireties by reference.

### TECHNICAL FIELD

The present disclosure relates to the field of driving devices, and in particular, to a rotary driving device and a method for correcting a system error of the rotary driving device.

### BACKGROUND

A rotary driving device can be applied to some mechanical structures that perform circular work, such as a crane turntable and a robot joints. However, due to a vibration and a friction of a system, there is a blocking force in a driving process of the rotary driving device, and the blocking force is easy to cause errors in a dynamic response process of the rotary driving device, so it becomes difficult to accurately control a motion process of the rotary driving device.

### SUMMARY

In view of above, it is necessary to provide a rotary driving device and a method for correcting a system error of the rotary driving device, which can correct errors in a dynamic response process of the rotary driving device.

The present disclosure provides a rotary driving device for driving a load to rotate, the rotary driving device includes a driven assembly, a driving assembly, a torque transmission member, a first torque sensor, and a second torque sensor. The driven assembly is configured for driving a load to rotate, and the driving assembly is configured for outputting torque. The driving assembly includes a fixed component and a rotating component, the rotating component is rotatably connected to the fixed component, the torque transmission member is connected to the rotating component and the driven assembly, the rotating component is configured to drive the driven assembly to rotate through the torque transmission member. The first torque sensor is connected to the fixed component and the torque transmission member and configured for detecting torque acting on the first torque sensor from the torque transmission member. The second torque sensor is disposed on the driven assembly and configured for detecting an output torque from the driving assembly.

In some embodiments, the fixed component includes a motor support and a motor stator, the rotating component includes a motor rotor. The motor support, the motor stator and the motor rotor form a rotating motor. The motor stator is fixedly disposed on the motor support, the motor rotor is rotatably connected to the motor support through a first bearing, and the motor stator is capable of driving the motor rotor to rotate. In this way, a reliability of the rotary driving device is fundamentally improved, and a maintenance cost of the rotary driving device is reduced, and a positioning accuracy of the rotary driving device is improved.

In some embodiments, the rotary driving device further includes a control component, and the control component is electrically connected to the rotating motor. The rotating motor further includes an incremental encoder, the incremental encoder is disposed on an end of the rotating motor, and the incremental encoder is configured for measuring a rotating speed of the motor rotor. By measuring and controlling the rotating speed of the rotating motor through the incremental encoder, the rotating speed of the load can be accurately controlled.

In some embodiments, the fixed component includes a mounting seat, and the mounting seat is fixedly connected to the motor support. The rotary driving device further includes a brake, and the brake is disposed at the mounting seat, and the brake is movably matched with the motor rotor to brake the motor rotor. In this way, a braking of the rotating motor can be better realized, so as to control the rotary driving device to stop operating at any time.

In some embodiments, the rotating component includes a wave generator, and the torque transmission member is a flexible gear. The driven assembly includes a rigid gear. The wave generator, the flexible gear, and the rigid gear form a harmonic reducer. The flexible gear is at least partially sleeved on the wave generator, and a part of the flexible gear sleeved on the wave generator cooperates with the wave generator to form an elliptical gear structure, an end of the elliptical gear structure along a long axis of the elliptical gear structure is meshed with the rigid gear, and an end of the flexible gear is fixedly connected with the first torque sensor.

In some embodiments, the flexible gear includes a meshing portion and a connecting portion, the meshing portion is in a cylindrical shape, the meshing portion is at least partially sleeved on the wave generator, and an outer wall of a part of the meshing portion which sleeved on the wave generator is meshed with an inner wall of the rigid gear. The connecting portion is defined by an end of the meshing portion away from the wave generator being folded outwards. The connecting portion is fixedly connected with the first torque sensor. In this way, it is convenient for the harmonic reducer to transmit a torque G1 to the first torque sensor through the flexible gear.

In some embodiments, the driven assembly further includes an output flange, the output flange is connected with the rigid gear and configured for connecting the load, and the rigid gear is capable of driving the load to rotate through the output flange. The second torque sensor is disposed between the output flange and the rigid gear. Thus, a structural stability of the rotary driving device is improved.

In some embodiments, the output flange includes a supporting portion and an assembly portion, the supporting portion is in a cylindrical shape. The assembly portion is defined by an end of the supporting portion being folded outwards. One side of the assembly portion is connected with the rigid gear, and the other side of the assembly portion is configured for connecting the load. And the rigid gear is capable of driving the load to rotate through the assembly portion, and the second torque sensor is disposed between the assembly portion and the rigid gear. The rotary driving device further includes a second bearing, the second bearing is sleeved on the supporting portion, and the supporting portion is rotatably connected to the driving assembly through the second bearing.

In some embodiments, the rotary driving device further includes a control component and an absolute encoder, the control component is electrically connected to the absolute encoder, and the absolute encoder is disposed on one end of the supporting portion away from the assembly portion. The absolute encoder is configured for measuring a rotation position of the output flange, and the control component is capable of adjusting a variation/change of a rotation angle of the output flange according to a measurement result of the absolute encoder.

In some embodiments, the first torque sensor is any one of a strain gauge torque sensor, a capacitive torque sensor, a piezoelectric torque sensor and a piezoresistive torque sensor.

In some embodiments, the second torque sensor is any one of a strain gauge torque sensor, a capacitive torque sensor, a piezoelectric torque sensor and a piezoresistive torque sensor.

The present disclosure further provides a method for correcting a system error of a rotary driving device, which is configured for correcting a system error of the above rotary driving devices, and the method for correcting a system error of the rotary driving device includes following steps:
disposing a load on a driven assembly;
starting a driving assembly to accelerate a rotation of the rotating component;
the rotating component accelerating a rotation of the driven assembly through the torque transmission member;
measuring a output torque G₂ from the driving assembly by a second torque sensor disposed on the driven assembly;
measuring a torque G₁ from the torque transmission member by a first torque sensor connected with the torque transmission member; and
correcting a system error of the rotary driving device by means of a formula: G₂−G₁=M*a, wherein M is a rotational inertia of the load, and a is an angular acceleration of the load.

For rotary driving device and the method for correcting the system error of the rotary driving device in the present disclosure, the driving assembly is first started, the driving assembly can drive the rotating component to accelerate its rotation, and the rotating component can transmit a torque to the driven assembly through the torque transmission member, so that the driven assembly also accelerates its rotation, and an accelerated rotation of the driven assembly will further drive the load to accelerates its rotation. The output torque G₂ of the driving assembly is divided into two parts, one part of the output torque causes an angular acceleration a of the load, and the other part of the output torque is offset by a reverse torque generated by the fixed component on the torque transmission member. In the related art, an output torque G₂ of the driving assembly is used as a torque that causes the load to generate an angular acceleration a; however, a part of the output torque G₂ of the driving assembly is offset by the reverse torque generated by the fixed component on the torque transmission member, so an actual torque that causes the load to generate the angular acceleration a is inconsistent with the output torque G₂ of the driving assembly, which will lead to system errors. In the present disclosure, the output torque G₂ of the driving assembly can be directly measured by the second torque sensor, and the first torque sensor can measure the torque G₁ generated by the torque transmission member on the fixed component. By means of the formula: G₂−G₁=M*a, the torque G₁ in the output torque G₂ of the driving assembly that fails to make the load produce an angular acceleration can be eliminated, so as to obtain the actual torque that makes the load produce angular acceleration by the driving assembly, and then correct the system error of the rotary driving device. Wherein M is a rotational inertia of the load, and a is an angular acceleration of the load. To sum up, the rotary driving device provided in the present disclosure eliminates the system error in a dynamic response process of the rotary driving device, thus being beneficial to a precise control of a motion process of the rotary driving device.

### BRIEF DESCRIPTION OF THE DRAWINGS

FIG. 1 is a sectional view of a rotary driving device in an embodiment.

Reference signs are as follows: 100 represents a load; 1 represents a driven assembly; 11 represents a rigid gear; 12 represents an output flange; 121 represents a supporting portion; 122 represents an assembly portion; 2 represents a driving assembly; 21 represents a fixed component; 211 represents a motor support; 212 represents a motor stator; 213 represents a mounting seat; 22 represents a rotating component; 221 represents a motor rotor; 222 represents a wave generator; 3 represents a torque transmission member; 31 represents a flexible gear; 311 represents a meshing portion; 312 represents a connecting portion; 4 represents a first torque sensor; 5 represents a second torque sensor; 6 represents a control component; 71 represents a first bearing; 72 represents a second bearing; 73 represents a third bearing; 81 represents an incremental encoder; 82 represents an absolute encoder; and 9 represents a brake.

### DETAILED DESCRIPTION

To make the above-mentioned objects, features and advantages of the present application more apparent and easier to understand, and the specific embodiments of the present application are described in detail below with reference to the accompanying drawings. Numerous specific details are set forth in the following description to facilitate a sufficient understanding of the present application. However, the present application can be implemented in many other ways different from that described herein, and a person skilled in the art may perform similar improvements without departing from the connotation of the present application, and therefore, the present application is not limited by the specific embodiments disclosed below.

In the description of the present application, it should be understood that the azimuth or positional relationship indicated by terms and the like is based on the azimuth or positional relationship shown in the attached drawings, only for the convenience of describing this application and simplifying the description, and does not indicate or imply that the device or element referred to must have a specific orientation, be constructed and operated in a specific orientation, so it cannot be understood as a limitation of this application.

In addition, if these terms “first” and “second” appear, these terms are only used for descriptive purposes, and cannot be understood as indicating or implying relative importance or implicitly indicating the number of indicated technical features. Thus, the features defined with “first” and “second” may explicitly or implicitly include at least one of the features. In the description of the present application, if there is a term “a plurality of”, the meaning of “a plurality of” is at least two, for example, two, three, etc., unless specifically defined otherwise.

In the present application, unless expressly specified and defined otherwise, the terms “mounted”, “connected”, “connected”, “fixed”, etc., should be construed broadly, unless expressly specified and defined otherwise. For example, it may be a fixed connection, or may be a detachable connection, or a whole; may be a mechanical connection, or may be an electrical connection; may be directly connected, or may be indirectly connected by means of an intermediate medium, may be a communication relationship between the interior of the two elements or an interaction relationship between the two elements, unless explicitly defined otherwise. For a person of ordinary skill in the art, the specific meanings of the above terms in this application may be understood according to specific situations.

In the present application, unless expressly specified and defined otherwise, if there is a similar description of the first feature in the second feature “upper” or “lower”, the meaning may be that the first feature is in direct contact with the second feature, or the first feature and the second feature are indirectly in contact with each other by means of the intermediate medium. Moreover, the first feature “above”, “above”, and “upper” of the second feature may be that the first feature is directly above or obliquely above the second feature, or merely indicates that the first feature horizontal height is higher than the second feature. The first feature “below”, “lower”, and “lower surface” of the second feature may be that the first feature is directly below or obliquely below the second feature, or merely indicates that the first feature horizontal height is less than the second feature.

It should be noted that if an element is referred to as being “fixed to” or “disposed on” another element, it may be directly on another element or intervening elements may also be present. If one element is considered to be “connected” another element, it may be directly connected to another element or may have a centering element at the same time. If present, the terms “vertical”, “horizontal”, “upper”, “lower”, “left”, “right”, and the like used in this application are for illustrative purposes only and are not shown as unique implementations.

Unless otherwise defined, all technical and scientific terms used herein have the same meaning as commonly understood by those skilled in the technical field of this application. The terminology used herein in the specification of this application is only for the purpose of describing specific embodiments, and is not intended to limit this application. As used herein, the term “or/and” includes any and all combinations of one or more related listed items.

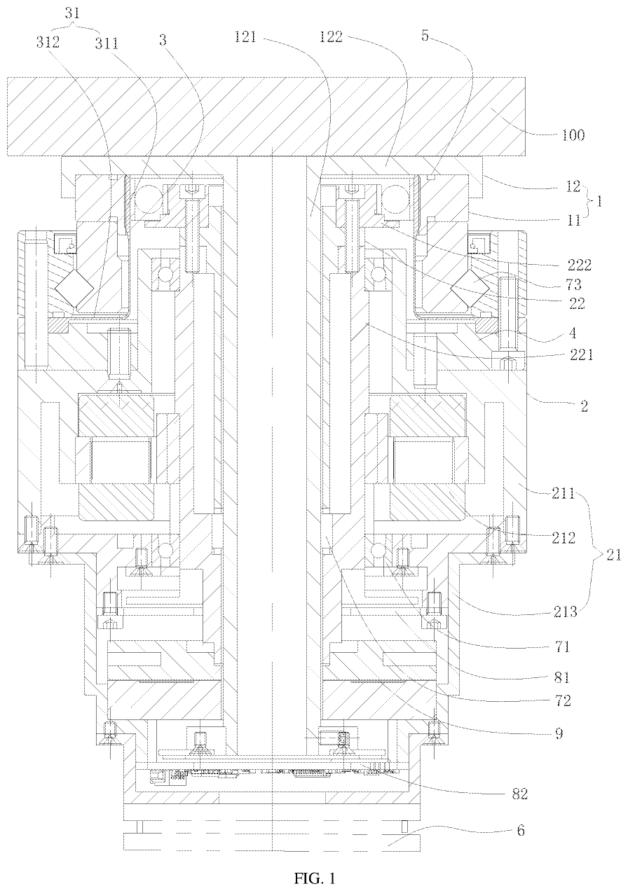

Referring to FIG. 1, a rotary driving device is widely used in some mechanical structures that perform circular work, such as a crane turntable and a robot joints. Usually, the rotary driving device is used to drive a load to rotate. The present disclosure provides a rotary driving device for driving a load 100 to rotate. The rotary driving device includes a driven assembly 1, a driving assembly 2, a torque transmission member 3, a first torque sensor 4 and a second torque sensor 5. The driving assembly 2 is regarded as a power source to output torque, and the driving assembly 2 includes a fixed component 21 and a rotating component 22, the rotating component 22 is rotatably connected to the fixed component 21 and the fixed component 21 can drive the rotating component 22 to rotate. The rotating component 22 is connected to the driven assembly 1 by the torque transmission member 3, so that an output torque of the driving assembly 2 is transmitted to the driven assembly 1 through the torque transmission member 3. The driven assembly 1 is connected with the load 100 to drive the load 100 to rotate. That is, the output torque of the driving assembly 2 is mainly used to drive the load 100 to rotate.

In order to accurately measure a torque acting on different parts of the rotary driving device, different torque sensors are arranged at different parts of the rotary driving device in the present disclosure. The first torque sensor 4 is connected with the fixed component 21 and the torque transmission member 3 to detect torque acting on the first torque sensor 4 by the torque transmission member 3. The second torque sensor 5 is disposed on the driven assembly 1 to detect the output torque of the driving assembly 2.

The first torque sensor 4 is any one of a strain gauge torque sensor, a capacitive torque sensor, a piezoelectric torque sensor and a piezoresistive torque sensor. The second torque sensor 5 is any one of a strain gauge torque sensor, a capacitive torque sensor, a piezoelectric torque sensor and a piezoresistive torque sensor. The strain gauge torque sensor, the capacitive torque sensor, the piezoelectric torque sensor and the piezoresistive torque sensor all have advantages of a fast strain response and a high measurement accuracy, which can measure a corresponding torque quickly and accurately.

Referring to FIG. 1, starting the driving assembly 2, the driving assembly 2 can drive the rotating component 22 to accelerate its rotation, and the rotating component 22 transmits a torque to the driven assembly 1 through the torque transmission member 3, so that the driven assembly 1 also accelerate its rotation and will drive the load 100 to accelerate its rotation. The output torque G₂ of the driving assembly 2 is divided into two parts, one part of the output torque causes the angular acceleration a of the load 100, and the other part of the output torque is offset by a reverse torque generated by the fixed component 21 on the torque transmission member 3. In the related art, the output torque G₂ of the driving assembly is used as a torque that causes the load to generate angular acceleration a; however, a part of the output torque G₂ of the driving assembly is offset by the reverse torque generated by the fixed component on the torque transmission member, so an actual torque that causes the load to generate angular acceleration a is inconsistent with the output torque G₂ of the driving assembly, which will lead to system errors. In the present disclosure, the output torque G₂ of the driving assembly 2 can be directly measured by the second torque sensor, and the first torque sensor can measure the torque G₁ generated by the torque transmission member 3 to the fixed component 21. By means of the formula: G₂-G₁=M*a, the torque G₁ in the output torque G₂ of the driving assembly 2 that fails to make the load 100 produce angular acceleration can be eliminated, so as to obtain the actual torque that makes the load 100 produce angular acceleration by the driving assembly 2, and then correct the system error of the rotary driving device, wherein M is a rotational inertia of the load 100, and a is an angular acceleration of the load 100. To sum up, the rotary driving device provided in the present disclosure eliminates the system error in a dynamic response process of the rotary driving device, thus being beneficial to a precise control of a motion process of the rotary driving device.

In an embodiment, referring to FIG. 1, a rotating motor is used as the power source in the rotary driving device. The fixed component 21 includes a motor support 211 and a motor stator 212, and the rotating component 22 includes a motor rotor 221. The motor support 211, the motor stator 212 and the motor rotor 221 form a rotating motor. The motor stator 212 is fixedly disposed on the motor support 211, the motor rotor 221 is rotatably connected to the motor support 211 through a first bearing 71. When the rotary driving device is started, the motor stator 212 can drive the motor rotor 221 to rotate under an action of a magnetic field, so that the driving assembly 2 can output torque. The rotating motor can be directly connected with the load 100 or connected with the load 100 through a reducer. In this way, a reliability of the rotary driving device is fundamentally improved, a maintenance cost of the rotary driving device is reduced, and a positioning accuracy of the rotary driving device is improved. In this embodiment, a definition of the motor rotor 221 is relatively broad. When a rotating motor is directly connected to the load 100, the rotating members between the load 100 and the motor stator 212 can be defined as the motor rotor 221. When the rotating motor is connected to the load 100 through a reducer, the rotating members between the reducer and the motor stator 212 can be defined as the motor rotor 221. Therefore, in order for the motor rotor 221 to better transmit torque, the motor rotor 221 will be designed in different shapes, so that the motor rotor 221 can be connected with the load 100 or the reducer.

In order to better control the rotary motor, in an embodiment, referring to FIG. 1, the rotary driving device is further provided with a control component 6 and an incremental encoder 81, and the control component 6 is electrically connected with the rotating motor and the incremental encoder 81, respectively. Specifically, the incremental encoder 81 is arranged at an end of the motor rotor 221, and the incremental encoder 81 can measure a rotating speed of the motor rotor 221 in real time, and then, the incremental encoder 81 transmits a data of a rotational speed of the rotating motor to the control component 6, and the control component 6 can control a variation of a rotational speed of the motor rotor 221 according to a measurement result of the incremental encoder 81, so that the rotational speed of the rotating motor can reach a target rotational speed. By measuring and controlling the rotating speed of the rotating motor through the incremental encoder 81, the rotating speed of the load 100 can be accurately controlled. The control component 6 can be a controller such as an industrial computer or a microprocessor.

Furthermore, referring to FIG. 1, in order to better realize a braking of the rotary motor and control the rotary driving device to stop operating at any time, the rotary driving device is further provided with a brake 9. The fixed component 21 includes a mounting seat 213, the mounting seat 213 is fixedly connected to the motor support 211, and the brake 9 is disposed at the mounting seat 213, and the brake 9 is movably matched with the motor rotor 221 to brake the motor rotor 221. When the brake 9 is in contact with the motor rotor 221, the motor rotor 221 decelerates under a friction of the brake 9. The tighter the fit between the brake 9 and the motor rotor 221, the faster the speed of the motor rotor 221 decreases. When the brake 9 is away from the motor rotor 221, the motor rotor 221 will not be subjected to a friction from the brake 9. Furthermore, an end of the motor rotor 221 is provided with a step structure, the brake 9 can be stopped at the step structure, and the brake 9 is movably matched with a surface of the step structure.

However, under the condition of the rotating speed of the rotating motor being too fast and a certain output power, reducing the rotating speed of the rotating motor will improve an output torque of the rotating motor, thus realizing a great torque transmission of the rotating motor at a low rotating speed. And in order to better reduce an output speed of the rotating motor, in an embodiment, referring to FIG. 1, a harmonic reducer is disposed between the load 100 and the rotating motor. The rotating component 22 includes a wave generator 222. The torque transmission member 3 can be a flexible gear 31. The driven assembly 1 includes a rigid gear 11. The wave generator 222, the flexible gear 31, and the rigid gear 11 form a harmonic reducer. The flexible gear 31 is at least partially sleeved on the wave generator 222, and a shape of a cross section of the wave generator 222 sleeved by the flexible gear 31 is elliptical, so, a part of the flexible gear 31 sleeved on the wave generator 222 cooperates with the wave generator 222 to form an elliptical gear structure, and a gear teeth of the elliptical gear structure is away from the wave generator 222. When the harmonic reducer is operating, an end of the elliptical gear structure along a long axis of the elliptical gear structure is meshed with the rigid gear 11, while an end of the elliptical gear structure along a short axis of the elliptical gear structure is completely disengaged from the rigid gear 11, and a part between the end of the elliptical gear structure along a long axis of the elliptical gear structure and the end of the elliptical gear structure along a short axis of the elliptical gear structure is in a transitional state of an incomplete engagement with the rigid gear 11. When the wave generator 222 rotates continuously under a drive of the motor rotor 221, a deformation of the flexible gear 31 is constantly changing, and a meshing state between the flexible gear 31 and the rigid gear 11 is also constantly changing. The meshing state between the flexible gear 31 and the rigid gear 11 repeats processes of meshing, complete meshing, meshing out, complete disengagement and meshing again, so that the rigid gear 11 rotates slowly along a same direction as the wave generator 222 relative to the flexible gear 31. In this embodiment, when the harmonic reducer works, the flexible gear 31 is fixedly connected to the fixed component 21, the motor rotor 221 drives the wave generator 222 to rotate, and the rigid gear 11 is used as a driven wheel to output rotation, thereby driving the load 100 to rotate. In a transmission process of the harmonic reducer, the wave generator 222 makes one revolution, and a number of cycles of deformation at a certain point on the flexible gear 31 is called a wave number, which is denoted by n, usually the wave number n is 2 or 3. When the wave number n is 2, the harmonic reducer is double-wave transmission, therefore, a structure of the harmonic reducer is relatively simple, and it is easy for the harmonic reducer to obtain a great transmission ratio.

Furthermore, in order to measure the torque G₁ generated by the torque transmission member 3 to the fixed component 21, an end of the flexible gear 31 is fixedly connected to the first torque sensor 4, and the first torque sensor 4 is fixedly connected to the motor support 211. Referring to FIG. 1, the flexible gear 31 includes a meshing portion 311 and a connecting portion 312, the meshing portion 311 is in a cylindrical shape, the meshing portion 311 is at least partially sleeved on the wave generator 222, and an outer wall of a part of the meshing portion 311 sleeved on the wave generator 222 is meshed with an inner wall of the rigid gear 11. The connecting portion 312 is defined by an end of the meshing portion 311 away from the wave generator 222 being folded outwards. The connecting portion 312 is fixedly connected with the first torque sensor 4. In this way, it is convenient for the harmonic reducer to transmit the torque G₁ to the first torque sensor 4 through the flexible gear 31.

In order to better connect the load 100 to the harmonic reducer, in an embodiment, referring to FIG. 1, an output flange 12 is arranged between the harmonic reducer and the load 100. Specifically, the driven assembly 1 further includes the output flange 12, the output flange 12 is fixedly connected with the rigid gear 11, and the load 100 is connected with the output flange 12, the rigid gear 11 is capable of driving the load 100 to rotate through the output flange 12. The second torque sensor 5 is disposed between the output flange 12 and the rigid gear 11.

Furthermore, in order to improve a structural stability of the rotary driving device, the output flange 12 includes a supporting portion 121 and an assembly portion 122 which are fixedly connected (as shown in FIG. 1). The supporting portion 121 is in a cylindrical shape. A second bearing 72 is sleeved outside the supporting portion 121. The supporting portion 121 is rotatably connected to the driving assembly 2 through the second bearing 72. Specifically, the supporting portion 121 is rotatably connected to the motor rotor 221 through the second bearing 72, thus improving the structural stability of the rotary driving device. The assembly portion 122 is formed by an end of the supporting portion 121 being folded outward. One side of the assembly portion 122 is connected with the rigid gear 11, and the other side of the assembly portion 122 is configured for connecting the load 100, and the rigid gear 11 is capable of driving the load 100 to rotate through the assembly portion 122, and the second torque sensor 5 is disposed between the assembly portion 122 and the rigid gear 11. Similarly, a third bearing 73 is sleeved outside the rigid gear 11, and the rigid gear 11 is rotatably connected to the motor support 211 through the third bearing 73, thus further improving the structural strength of the whole rotary driving device.

Furthermore, in order to better realize a control of the output flange 12, in an embodiment, referring to FIG. 1, the rotary driving device is further provided with an absolute encoder 82, and the control component 6 is electrically connected with the absolute encoder 82. The absolute encoder 82 is disposed on one end of the supporting portion 121 away from the assembly portion 122. The absolute encoder 82 is configured for measuring a rotation position of the output flange 12, then, the absolute encoder 82 transmits a position information of the output flange 12 to the control component 6, the control component 6 is capable of adjusting a variation of a rotation angle of the output flange 12 according to a measurement result of the absolute encoder 82.

The present disclosure further provides a method for correcting a system error of the rotary driving device, which is configured for correcting a system error of the above rotary driving devices. The method for correcting a system error of the rotary driving device includes following steps:
disposing a load on a driven assembly;
starting a driving assembly to accelerate a rotation of the rotating component;
the rotating component accelerating a rotation of the driven assembly through the torque transmission member;
measuring a output torque G₂ from the driving assembly by a second torque sensor disposed on the driven assembly;
measuring a torque G₁ from the torque transmission member by a first torque sensor connected with the torque transmission member; and
correcting a system error of the rotary driving device by means of a formula: G₂-G₁=M*a, wherein M is a rotational inertia of the load, and a is an angular acceleration of the load.

In detail, the method for correcting the system error of the rotary driving device provided by the present disclosure includes following steps:

The load 100 is detachably mounted on the output flange 12 by a fastener. Then the control component 6 is configured to start the rotating motor, and the motor stator 212 drives the motor rotor 221 to rotate, and the motor rotor 221 drives the harmonic reducer to rotate. Moreover, after the harmonic reducer converts a high-speed rotation output by the rotating motor into a low-speed rotation, the output flange 12 connected to the harmonic reducer rotates with the rigid gear 11, thereby driving the load 100 to rotate together. The rotating speed of the rotating motor increases from zero, so both the rotating motor and the load 100 accelerate rotation. During an acceleration of the load 100 and the output flange 12, the second torque sensor 5 can measure the output torque G₂ of the driving motor. An end of the flexible gear 31 is fixedly connected to the first torque sensor 4, so the flexible gear 31 does not rotate, so the first torque sensor 4 can measure the torque G₁ transmitted by the flexible gear 31 to the motor support 211, and the torque G₁ cannot act on the load 100 and not make the load 100 generate angular acceleration. Therefore, by the means of the formula: G₂−G₁=M*a, the torque G₁ which cannot make the load 100 generate angular acceleration is eliminated, thus correcting the system error of the linear drive device.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

One of ordinary skill in the art should recognize that the above embodiments are used only to illustrate the present disclosure and are not used to limit the present disclosure, and that appropriate variations and improvements to the above embodiments fall within the protection scope of the present disclosure so long as they are made without departing from the substantial spirit of the present disclosure.

What is claimed is:

1. A rotary driving device, for driving a load to rotate, comprising:
a driven assembly for driving the load to rotate;
a driving assembly for outputting torque, wherein the driving component comprises a fixed component and a rotating component, the rotating component is rotatably connected to the fixed component;
a torque transmission member connected to the rotating component and the driven assembly, wherein the rotating component is configured to drive the driven assembly to rotate through the torque transmission member;
a first torque sensor connected to the fixed component and the torque transmission member and configured for detecting a torque acting on the first torque sensor from the torque transmission member; and
a second torque sensor disposed on the driven assembly and configured for detecting an output torque from the driving assembly.

2. The rotary driving device of claim 1, wherein the fixed component comprises a motor support and a motor stator, the rotating component comprises a motor rotor;
the motor support, the motor stator and the motor rotor form a rotating motor;
the motor stator is fixedly disposed on the motor support, the motor rotor is rotatably connected to the motor support through a first bearing, and the motor stator is capable of driving the motor rotor to rotate.

3. The rotary driving device of claim 2, further comprising a control component, wherein the control component is electrically connected to the rotating motor; the rotating motor further comprises an incremental encoder, the incremental encoder is disposed on an end of the rotating motor, and the incremental encoder is configured for measuring a rotating speed of the motor rotor; the control component is capable of adjusting a variation of a rotational speed of the motor rotor according to a measurement result of the incremental encoder.

4. The rotary driving device of claim 2, wherein the fixed component comprises a mounting seat, the mounting seat is fixedly connected to the motor support; the rotary driving device further comprises a brake, and the brake is disposed at the mounting seat, and the brake is movably matched with the motor rotor to brake the motor rotor.

5. The rotary driving device of claim 1, wherein the rotating component comprises a wave generator, the torque transmission member is a flexible gear, the driven assembly comprises a rigid gear;
the wave generator, the flexible gear, and the rigid gear form a harmonic reducer;
the flexible gear is at least partially sleeved on the wave generator, and a part of the flexible gear sleeved on the wave generator cooperates with the wave generator to form an elliptical gear structure, an end of the elliptical gear structure along a long axis of the elliptical gear structure is meshed with the rigid gear, and an end of the flexible gear is fixedly connected with the first torque sensor.

6. The rotary driving device of claim 5, wherein the flexible gear comprises a meshing portion and a connecting portion, the meshing portion is in a cylindrical shape, the meshing portion is at least partially sleeved on the wave generator, and an outer wall of a part of the meshing portion sleeved on the wave generator is meshed with an inner wall of the rigid gear;
the connecting portion is defined by an end of the meshing portion away from the wave generator being folded outwards;
the connecting portion is fixedly connected with the first torque sensor.

7. The rotary driving device of claim 5, wherein the driven assembly further comprises an output flange, the output flange is connected with the rigid gear and configured for connecting the load, the rigid gear is capable of driving the load to rotate through the output flange;
the second torque sensor is disposed between the output flange and the rigid gear.

8. The rotary driving device of claim 7, wherein the output flange comprises a supporting portion and an assembly portion, the supporting portion is in a cylindrical shape, the assembly portion is defined by an end of the supporting portion being folded outwards, one side of the assembly portion is connected with the rigid gear, and the other side of the assembly portion is configured for connecting the load, and the rigid gear is capable of driving the load to rotate through the assembly portion, and the second torque sensor is disposed between the assembly portion and the rigid gear;
the rotary driving device further comprises a second bearing, the second bearing is sleeved on the supporting portion, and the supporting portion is rotatably connected to the driving assembly through the second bearing.

9. The rotary driving device of claim 8, further comprising a control component and an absolute encoder, wherein the control component is electrically connected to the absolute encoder, and the absolute encoder is disposed on one end of the supporting portion away from the assembly portion;
the absolute encoder is configured for measuring a rotation position of the output flange, the control component is capable of adjusting a variation of a rotation angle of the output flange according to a measurement result of the absolute encoder.

10. The rotary driving device of claim 1, wherein the first torque sensor is any one of a strain gauge torque sensor, a capacitive torque sensor, a piezoelectric torque sensor and a piezoresistive torque sensor; and/or,
the second torque sensor is any one of a strain gauge torque sensor, a capacitive torque sensor, a piezoelectric torque sensor and a piezoresistive torque sensor.

11. A method for correcting a system error of a rotary driving device, configured for correcting a system error of the rotary driving device of claim 1 and comprising following steps:
disposing a load on a driven assembly;
starting a driving assembly to accelerate a rotation of the rotating component;
the rotating component accelerating a rotation of the driven assembly through the torque transmission member;
measuring a output torque G₂ from the driving assembly by a second torque sensor disposed on the driven assembly;
measuring a torque G₁ from the torque transmission member by a first torque sensor connected with the torque transmission member; and
correcting a system error of the rotary driving device by means of a formula: G₂−G₁=M*a, wherein M is a rotational inertia of the load, and a is an angular acceleration of the load.

12. The method of claim 11, wherein the fixed component comprises a motor support and a motor stator, the rotating component comprises a motor rotor;
the motor support, the motor stator and the motor rotor form a rotating motor;
the motor stator is fixedly disposed on the motor support, the motor rotor is rotatably connected to the motor support through a first bearing, and the motor stator is capable of driving the motor rotor to rotate.

13. The method of claim 12, further comprising a control component, wherein the control component is electrically connected to the rotating motor; the rotating motor further comprises an incremental encoder, the incremental encoder is disposed on an end of the rotating motor, and the incremental encoder is configured for measuring a rotating speed of the motor rotor; the control component is capable of adjusting a variation of a rotational speed of the motor rotor according to a measurement result of the incremental encoder.

14. The method of claim 12, wherein the fixed component comprises a mounting seat, the mounting seat is fixedly connected to the motor support; the rotary driving device further comprises a brake, and the brake is disposed at the mounting seat, and the brake is movably matched with the motor rotor to brake the motor rotor.

15. The method of claim 11, wherein the rotating component comprises a wave generator, the torque transmission member is a flexible gear, the driven assembly comprises a rigid gear;
the wave generator, the flexible gear, and the rigid gear form a harmonic reducer;
the flexible gear is at least partially sleeved on the wave generator, and a part of the flexible gear sleeved on the wave generator cooperates with the wave generator to form an elliptical gear structure, an end of the elliptical gear structure along a long axis of the elliptical gear structure is meshed with the rigid gear, and an end of the flexible gear is fixedly connected with the first torque sensor.

16. The method of claim 15, wherein the flexible gear comprises a meshing portion and a connecting portion, the meshing portion is in a cylindrical shape, the meshing portion is at least partially sleeved on the wave generator, and an outer wall of a part of the meshing portion sleeved on the wave generator is meshed with an inner wall of the rigid gear;
the connecting portion is defined by an end of the meshing portion away from the wave generator being folded outwards;
the connecting portion is fixedly connected with the first torque sensor.

17. The method of claim 15, wherein the driven assembly further comprises an output flange, the output flange is connected with the rigid gear and configured for connecting the load, the rigid gear is capable of driving the load to rotate through the output flange;
the second torque sensor is disposed between the output flange and the rigid gear.

18. The method of claim 17, wherein the output flange comprises a supporting portion and an assembly portion, the supporting portion is in a cylindrical shape, the assembly portion is defined by an end of the supporting portion being folded outwards, one side of the assembly portion is connected with the rigid gear, and the other side of the assembly portion is configured for connecting the load, and the rigid gear is capable of driving the load to rotate through the assembly portion, and the second torque sensor is disposed between the assembly portion and the rigid gear;
the rotary driving device further comprises a second bearing, the second bearing is sleeved on the supporting portion, and the supporting portion is rotatably connected to the driving assembly through the second bearing.

19. The method of claim 18, further comprising a control component and an absolute encoder, wherein the control component is electrically connected to the absolute encoder, and the absolute encoder is disposed on one end of the supporting portion away from the assembly portion;
the absolute encoder is configured for measuring a rotation position of the output flange, the control component is capable of adjusting a variation of a rotation angle of the output flange according to a measurement result of the absolute encoder.

20. The method of claim 11, wherein the first torque sensor is any one of a strain gauge torque sensor, a capacitive torque sensor, a piezoelectric torque sensor and a piezoresistive torque sensor; and/or,
the second torque sensor is any one of a strain gauge torque sensor, a capacitive torque sensor, a piezoelectric torque sensor and a piezoresistive torque sensor.
